(19) United States
(12) Patent Application Publication
(10) Pub. No.: US 2014/0344562 A1
(43) Pub. Date: Nov. 20, 2014

(54) METHOD AND DEVICE FOR PREVENTING ACCESS TO ADMINISTRATIVE PRIVILEGE

(71) Applicant: Samsung Electronics Co., Ltd., Suwon-si (KR)

(72) Inventors: Inkyo KIM, Yongin-si (KR); Sangho LEE, Seongnam-si (KR); Doyoung KIM, Hwaseong-si (KR); Eunhui BAE, Seoul (KR); Kyunggeun LEE, Seongnam-si (KR); Yong CHANG, Seongnam-si (KR)

(73) Assignee: Samsung Electronics Co., Ltd., Suwon-si (KR)

(21) Appl. No.: 14/282,499

(22) Filed: May 20, 2014

(30) Foreign Application Priority Data
May 20, 2013 (KR) 10-2013-0056310

(51) Int. Cl. G06F 21/57

(52) U.S. Cl. CPC G06F 21/575
USPC 713/2

(57) ABSTRACT

A method and a device for preventing access to an administrative privilege are provided. The method includes acquiring a flash memory identifier from a flash memory, starting kernel loading, decoding an encrypted administrative privilege granting code using the flash memory identifier, and completing booting when the decoding succeeds. According to an embodiment of the present disclosure, the code for accessing the administrative privilege is encrypted using the identifier of the flash memory so that the unique password code can be loaded for each device, thereby enhancing the system security.

### CROSS-REFERENCE TO RELATED APPLICATION(S)

This application claims the benefit under 35 U.S.C. §119(a) of a Korean patent application filed on May 20, 2013 in the Korean Intellectual Property Office and assigned Serial No. 10-2013-0056310, the entire disclosure of which is hereby incorporated by reference.

### TECHNICAL FIELD

The present disclosure relates to a method and a device for preventing access to an administrative privilege. More particularly, the present disclosure relates to a method and a device for encrypting a code for accessing an administrative privilege.

### BACKGROUND

In a device using an open system such as a mobile device, a user of the device can easily access an administrative privilege (e.g., a root privilege) of the corresponding device to change or modify system code as desired, without needing authentication.

FIG. 1 is a view schematically illustrating a method of accessing an unauthenticated administrative privilege according to the related art.

Referring to FIG. 1, when a device 100 is booted up, a user may identify a kernel code for defining a user privilege, and may access an administrative privilege by changing the kernel code.

That is, a boot loader is loaded in operations 110 and 115, and the user may change an administrative privilege granting code 130 when a kernel is loaded in operation 120. The user may identify the administrative privilege granting code 130 defining the user privilege of the system, and may change the administrative privilege granting code 130 to access the system administrative privilege. That is, the user may change the basic administrative privilege granting code 130 of the device to the modified administrative privilege granting code 140 representing that the administrative privilege of the device 100 can be accessed.

In the case where the user creates the modified administrative privilege granting code 140 by which the administrative privilege can be accessed, and changes the basic administrative privilege granting code 130 to the modified administrative privilege granting code 140, the user may access the administrative privilege for the device 100.

The change of the administrative privilege granting code may be performed during or after the booting process.

As described above, in the case of the device of the related art, the user can easily access the administrative privilege by simply changing the administrative privilege granting code.

However, a problem of system stability may arise through modification of a device driver, or a deterioration of security not recognized by the user may occur. Furthermore, illegal programs such as a hacking program can be installed, and thus, security problems may occur in that the device may be used for hacking. Furthermore, there is a probability of abusing the system by the user such as maliciously using the device by accessing the administrative privilege of the device and then restoring the system code to the original code.

That is, in the case of an open system such as a mobile terminal, due to the system disclosure, anyone can easily access the administrative privilege only with basic knowledge about the device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a device for preventing access to an administrative privilege of a device by an unauthenticated user.

Another aspect of the present disclosure is to provide a high security method of preventing access to the administrative privilege by using an identifier of physically applied hardware.

The technical subjects pursued in the present disclosure may not be limited to those mentioned above, and other technical subjects which are not mentioned may be clearly understood, through the following descriptions, by those skilled in the art of the present disclosure.

In accordance with an aspect of the present disclosure, a method of preventing access to an administrative privilege of a device is provided. The method includes acquiring a flash memory identifier from a flash memory, starting kernel loading, decoding an encrypted administrative privilege granting code using the flash memory identifier, and completing booting when the decoding succeeds.

The method may further include generating a system error when the decoding fails.

The starting of the kernel loading may include loading a boot loader, loading a flash memory decoding module, and starting the kernel loading when the flash memory decoding module is loaded.

The method may further include generating a system error when the loading of the flash memory decoding module fails.

The decoding of the administrative privilege granting code may include determining whether the flash memory identifier is the same as a pre-stored identifier, and decoding the encrypted administrative privilege granting code using the flash memory identifier when the flash memory identifier is the same as the pre-stored identifier.

The method may further include generating a system error when the flash memory identifier is not the same as the pre-stored identifier.

The method may further include acquiring an identifier of the flash memory from the flash memory, and encrypting an administrative privilege granting code using the identifier of the flash memory.

The encrypting of the administrative privilege granting code may include encrypting the administrative privilege granting code with an encryption executing code by using the identifier of the flash memory, and deleting the encryption executing code.

In accordance with another aspect of the present disclosure, a device for preventing access to an administrative privilege is provided. The device includes a flash memory comprising a flash memory identifier, and a controller configured to acquire a flash memory identifier from a flash memory, start kernel loading, decode an encrypted administrative privilege granting code using the flash memory identifier, and complete booting when the decoding succeeds.

As described above, the present disclosure provides a computer system and a method of preventing access to the administrative privilege of the computer system, which can encrypt a code for accessing the administrative privilege using the identifier of the flash memory to load the unique password code for each device, thereby enhancing the system security.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view schematically illustrating a method of accessing an unauthenticated administrative privilege according to the related art;

FIG. 2 is a flowchart schematically illustrating an example of a method of encrypting an administrative privilege granting code in a computer system according to an embodiment of the present disclosure;

FIG. 3 is a flowchart schematically illustrating an example of a method of encrypting an administrative privilege granting code in a computer system according to an embodiment of the present disclosure;

FIGS. 4 and 5 illustrate an example of a block diagram of a device including a computer system according to an embodiment of the present disclosure;

FIG. 6 is a flowchart schematically illustrating an example of a booting method in a computer system according to an embodiment of the present disclosure;

FIG. 7 is a flowchart schematically illustrating an example of a booting method in a computer system according to an embodiment of the present disclosure;

FIG. 8 is a view schematically illustrating a booting process of a computer system according to an embodiment of the present disclosure; and

FIG. 9 is a block diagram schematically illustrating a computer system according to an embodiment of the present disclosure.

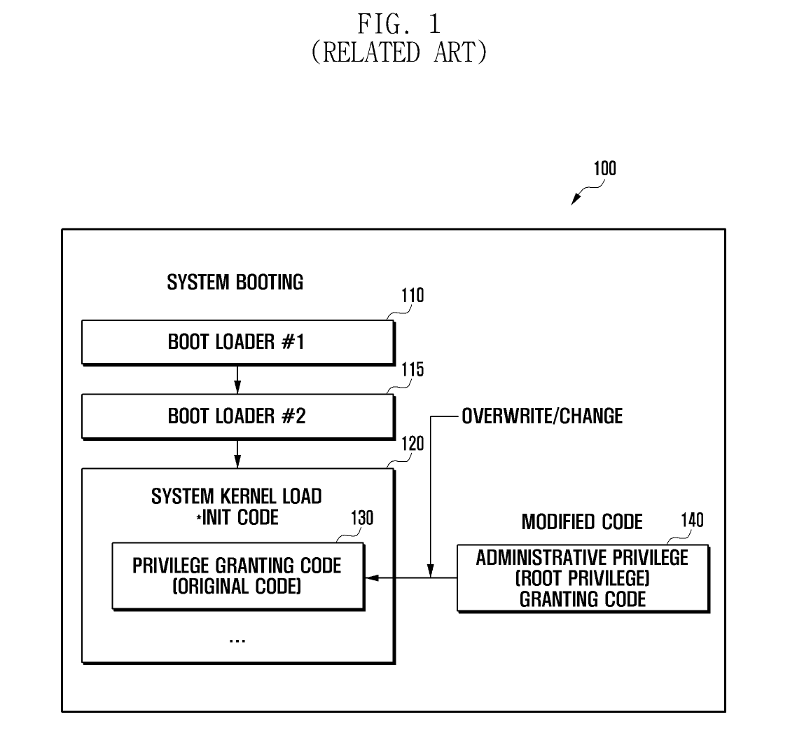

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An administrative privilege granting code is difficult to encrypt in advance and load in a memory for each device. Accordingly, an encryption target code may be encrypted when the corresponding device is first executed. At this time, the encryption target code may be an administrative privilege granting code, but is not limited thereto. For example, any code which is not desired to be changed by an unauthenticated user may be included in the encryption target code.

In the present disclosure, the device may include a mobile terminal. However, without being limited thereto, the device may also be a home network system, a notebook computer, a desktop computer, or the like.

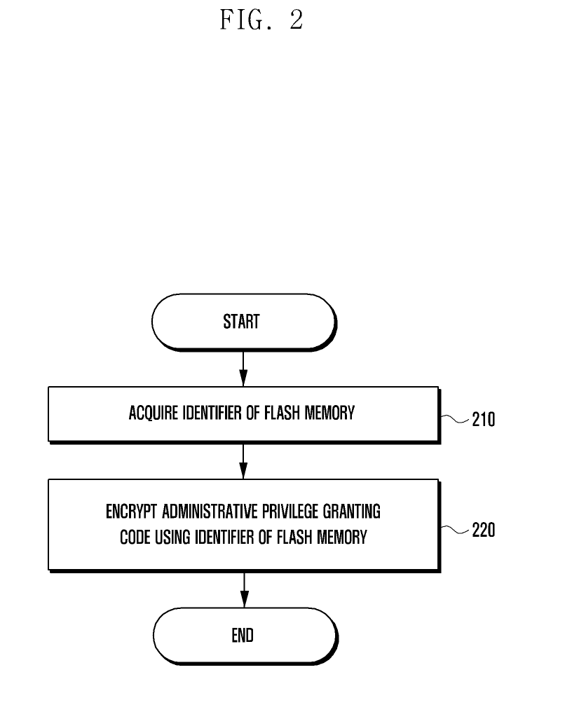

FIG. 2 is a flowchart schematically illustrating an example of a method of encrypting an administrative privilege granting code in a device according to an embodiment of the present disclosure.

Referring to FIG. 2, the device acquires a flash memory identifier from a flash memory in operation 210. The identifier of the flash memory, which is a physically unique identifier for each flash memory, may be Enhanced Media Identification (EMID) stored in a specific area of the flash memory. The EMID may be recorded once in the specific area of the flash memory. From that point on, writing for the corresponding area may be restricted, and reading for the corresponding area may be performed only through a special interface.

After acquiring the identifier of the flash memory in operation 210, the device may encrypt an administrative privilege granting code using the acquired identifier of the flash memory in operation 220. At this time, since the identifier of the flash memory is unique to the flash memory, the device may differently configure the encrypted administrative privilege granting code for each device when performing the encryption using the identifier of the flash memory.

The administrative privilege granting code may be encrypted when the device is first executed. For example, in the case where the device includes a mobile terminal, when the mobile terminal is first turned on and booted up, a controller may acquire the identifier of the flash memory from the flash memory. Thereafter, the controller may encrypt the unencrypted administrative privilege granting code stored in the memory using the acquired identifier of the flash memory, and may store the encrypted administrative privilege granting code in the memory. In this way, the device according to the embodiment of the present disclosure may secure the different encrypted administrative privilege granting code for each device.

In this case, the identifier of the flash memory is unique to each flash memory as described above, and thus, a user may not easily obtain the identifier of the flash memory. Accordingly, the administrative privilege granting code is encrypted in a different way for each device so that it may be difficult for a user desiring to abnormally access an administrative privilege to arbitrarily change the encrypted administrative privilege granting code. Furthermore, the encrypted administrative privilege granting code is different for each device so that it may not be easy for the user desiring to abnormally access the administrative privilege to identify the code which has to be changed for access to the administrative privilege.

In addition, as will be described below, in a case where a user arbitrarily changes the encrypted administrative privilege granting code to another code, the changed code may not be decoded using the identifier of the flash memory when the device is booted up.

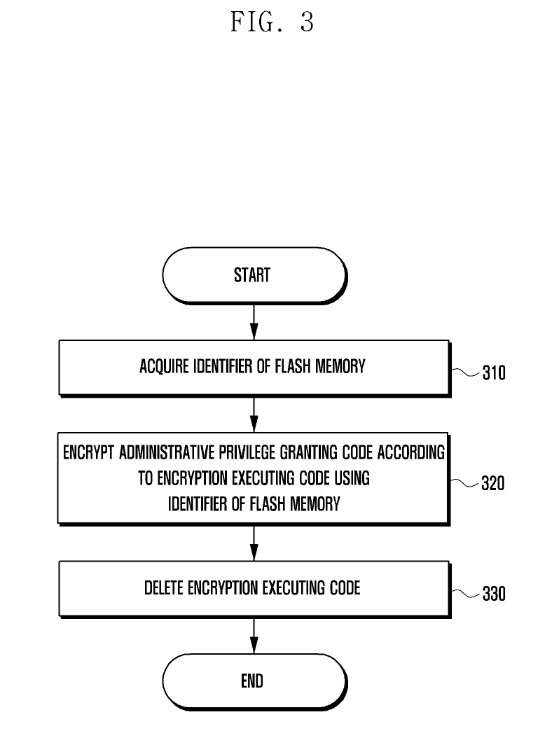

FIG. 3 is a flowchart schematically illustrating an example of a method of encrypting an administrative privilege granting code in a device according to an embodiment of the present disclosure.

As described above with reference to FIG. 2, an encryption target code may be encrypted when the corresponding device is first executed. The encryption target code may include an administrative privilege granting code.

Referring to FIG. 3, the device may acquire an identifier of a flash memory from the flash memory in operation 310. The identifier of the flash memory, which is a physically unique identifier for each flash memory, may be an EMID stored in a specific area of the flash memory.

In operation 320, the device may encrypt the administrative privilege granting code according to an encryption executing code using the identifier of the flash memory. The encryption executing code is a routine for encrypting the administrative privilege granting code using the identifier of the flash memory, and the device encrypts the administrative privilege granting code according to the encryption executing code.

The encryption executing code may request the identifier of the flash memory from the flash memory, and may acquire the identifier of the flash memory according to the request. When the encryption executing code has acquired the identifier of the flash memory which is unique to each device, the device may encrypt the administrative privilege granting code according to an encryption method.

The device may obtain the encrypted administrative privilege granting code which is unique to the device, by encrypting the administrative privilege granting code according to the encryption executing code using the identifier of the flash memory.

After the administrative privilege granting code is completely encrypted in operation 320, the device may delete the encryption executing code by which the encryption has been performed, in operation 330. As the encryption executing code is deleted, the information is removed on the method by which the administrative privilege granting code has been encrypted, thereby preventing the encryption method from being discerned after the encryption target code has been encrypted.

The administrative privilege granting code may be encrypted when the device is first executed. For example, in the case where the device includes a mobile terminal, when the mobile terminal is first turned on and booted up, a controller may acquire the identifier of the flash memory from the flash memory. Thereafter, the controller may encrypt the administrative privilege granting code according to the encryption executing code using the acquired identifier of the flash memory, change the unencrypted administrative privilege granting code basically stored to the encrypted administrative privilege granting code, and store the encrypted administrative privilege granting code.

In this way, the device may encrypt the administrative privilege granting code using the physically different identifier for each flash memory, thereby securing the different encrypted administrative privilege granting code for each device. Furthermore, the encryption executing code for encrypting the administrative privilege granting code may be deleted as soon as the administrative privilege granting code is encrypted when the device is first executed.

In this case, since the administrative privilege granting code is encrypted using the physically different identifier for each flash memory and the encryption executing code is deleted from the device, it may be difficult for a user desiring to abnormally access the administrative privilege to arbitrarily change the encrypted administrative privilege granting code.

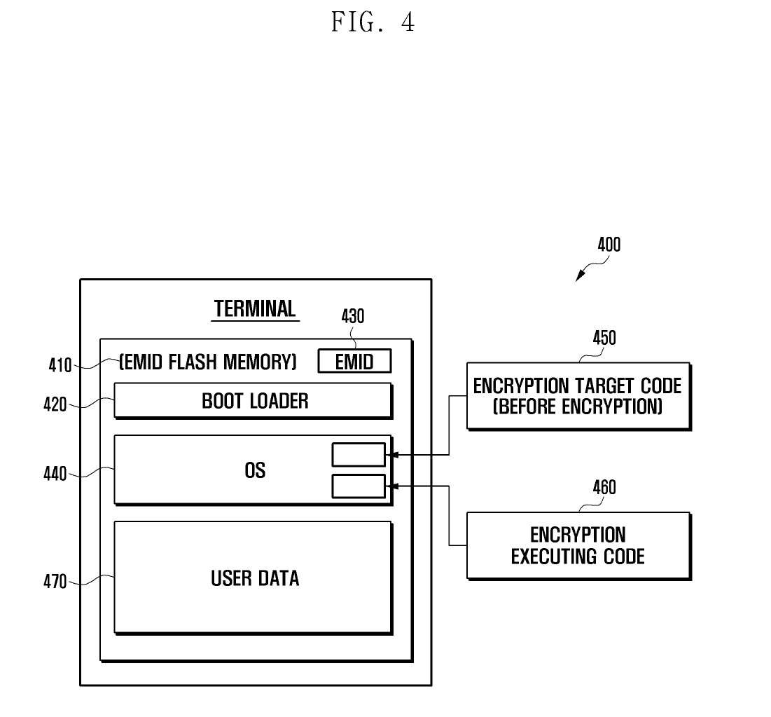

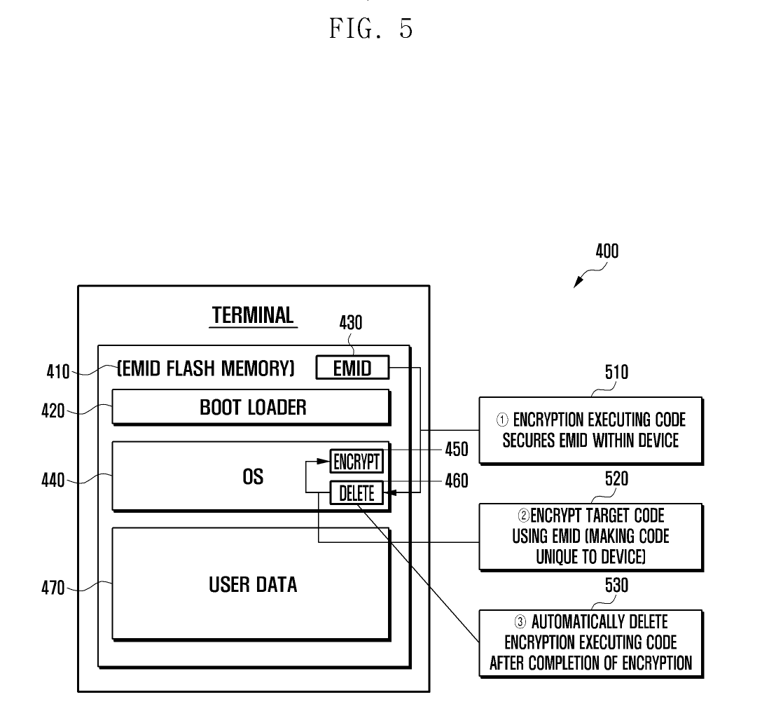

FIGS. 4 and 5 illustrate an example of a block diagram of a device according to an embodiment of the present disclosure.

Although the device according to the embodiment of the present disclosure includes a terminal 400 in FIGS. 4 and 5, the device may also be a home network system, a notebook computer, a desktop computer, or the like, without being limited thereto.

Referring to FIG. 4, the terminal 400 may include a flash memory 410 including EMID which is a unique identifier, and a controller (not illustrated). The flash memory 410 may be divided into an EMID storage area 430, a boot loader area 420, an Operating System (OS) area 440, and a user data area 470.

The OS area 440 may include an encryption target code 450 and an encryption executing code 460. Although the example of the encryption target code 450 being an administrative privilege granting code has been given, the encryption target code is not limited thereto, and any code which is not desired to be changed by an unauthenticated user in addition to the administrative privilege granting code may be included in the encryption target code 450.

The EMID, which is a physically unique identifier for each flash memory 410, may be stored in the EMID storage area 430. The EMID may be recorded once in the EMID storage area 430 when the flash memory 410 is first manufactured, and from that point on, writing for the corresponding EMID storage area 430 may be restricted. In addition, reading for the EMID storage area 430 may be performed only through a specific interface. For example, the EMID stored in the EMID storage area 430 may be read only by loading the encryption executing code 460 or the boot loader 420, and may not be read according to a user's arbitrary command.

Referring to FIG. 5, the terminal 400 according to an embodiment of the present disclosure may encrypt the encryption target code 450 stored in the OS area 440, when first executed. As described above, the encryption target code 450 may be the administrative privilege granting code.

When the terminal 400 is first booted up, the controller (not illustrated) starts to boot up the terminal 400 by loading the boot loader. While the terminal 400 is first being booted up, the encryption executing code 460 may acquire an identifier (e.g., EMID) of the flash memory from the EMID storage area 430 of the flash memory 410 in operation 510.

In operation 520, the encryption executing code 460 encrypts the encryption target code 450 according to the encryption method using the EMID which has been secured in operation 510. At this time, the acquired EMID is a unique identifier for each flash memory, and thus, the encryption target code which has been encrypted by the EMID may be changed to a uniquely encrypted code.

After the encryption target code 450 is completely encrypted, changed to the encrypted code, and stored in the memory, the encryption executing code 460 may be automatically deleted in operation 530. The deletion of the encryption executing code 460 makes it possible to prevent an unauthenticated user from acquiring the information on the encryption method for the code encrypted in operation 520 after the encryption has been performed.

In the case where the encryption target code 450 is manufactured without encryption thereof and then encrypted as illustrated in FIGS. 4 and 5, without being differently encrypted in advance for each device and loaded in the flash memory 410, the terminal 400 may be prepared with one image. When the terminal 400 is first booted up, the unique identifier of the flash memory 410 is acquired, and the encryption target code 450 is encrypted according to the encryption executing code 460, so that the first loaded encryption target code 450 may be changed to the unique encrypted code for each device through the different encryption for each terminal 400.

The method has been described above for encrypting the encryption target code including the administrative privilege granting code in the device according to the embodiment of the present disclosure.

Hereinafter, a process will be described of booting up a device according to an embodiment of the present disclosure.

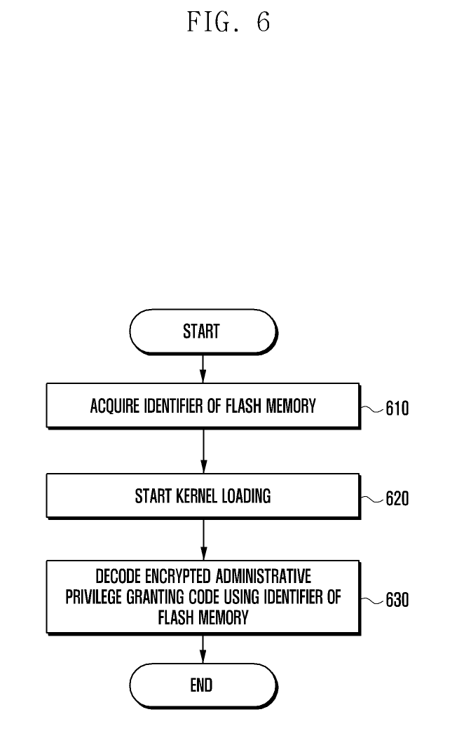

FIG. 6 is a flowchart schematically illustrating an example of a booting method in a device according to an embodiment of the present disclosure.

A booting process for the use of a user will be described for the device for which the administrative privilege granting code has been encrypted using the identifier of the flash memory as described above.

Since the administrative privilege granting code according to an embodiment of the present disclosure has been encrypted using the identifier of the flash memory and stored in the memory, for the use of the device, a procedure is necessary to identify whether the encrypted administrative privilege granting code has been changed.

Referring to FIG. 6, the controller of the device according to the embodiment of the present disclosure acquires the identifier of the flash memory identifier in operation 610. The identifier of the flash memory which is a unique identifier of the flash memory of the device may be an EMID.

In operation 620, kernel loading of the system is initiated. When the kernel loading is initiated, a data structure used by a process, a memory, and a kernel is initialized.

After the kernel loading is initiated, the controller may also acquire the identifier of the flash memory.

In the process of the kernel loading, in operation 630, the controller decodes the encrypted administrative privilege granting code using the identifier of the flash memory acquired in operation 610. When the decoding of the administrative privilege granting code succeeds in operation 630, the device is booted up through a normal booting process. When the decoding of the administrative privilege granting code fails, a system error may occur.

In the device according to an embodiment of the present disclosure, the administrative privilege granting code has been differently encrypted for each device using the identifier of the flash memory, and the encrypted administrative privilege granting code may also be decoded using the identifier of the flash memory. That is, the administrative privilege granting code has been encrypted with the identifier of the flash memory which is unique to the device, and the encrypted administrative privilege granting code is decoded with the identifier of the flash memory which has been used for the encryption. Accordingly, in one system, the encrypted administrative privilege granting code may be decoded only through the one specific identifier of the flash memory.

Due to this, an arbitrary code change by an unauthenticated user may be fundamentally prevented. That is, in the case where the encrypted administrative privilege granting code is changed to the unencrypted administrative privilege granting code, when decoding is attempted with the identifier of the flash memory used for the encryption, the decoding may not be normally performed, and an error message may be generated.

Furthermore, since the unique identifier of the flash memory is used in the decoding process, when the unauthenticated user attempts to access the administrative privilege such as to change the encrypted administrative privilege granting code, the decoding process may not be performed, thereby blocking the attempt to access the administrative privilege. That is, in the case where the administrative privilege granting code of the present device is changed to the administrative privilege granting code encrypted with an identifier of another flash memory, a device according to the present disclosure performs the decoding process with the identifier of the flash memory according to the present device. At this time, since the identifier used for the encryption and the identifier used for the decoding are different from each other, namely, the decoding is not performed according to the normal decoding code, the decoding may not be performed, and an error message may be generated.

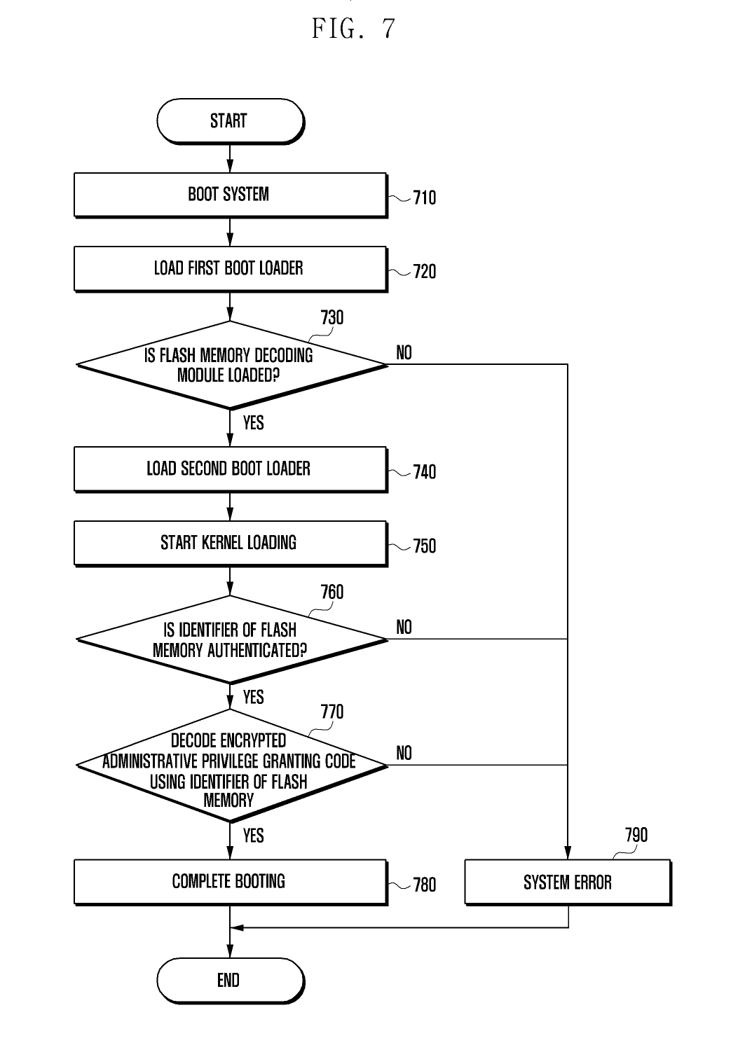

FIG. 7 is a flowchart schematically illustrating an example of a booting method in a device according to an embodiment of the present disclosure.

Referring to FIG. 7, a controller starts to boot up a system in operation 710, and loads a first boot loader in operation 720. The first boot loader may be configured to have a function of performing a Power-On Self Test (POST) for an initial system operation of an embedded system and a function of setting a communication interface required for communication with an external server by optimizing a communication device connected with the external server. The POST function for the initial system operation implies a series of diagnosis test functions for operating the Basic Input/Output System (BIOS) of the embedded system so as to identify whether hardware, for example, a keyboard ram disk driver correctly operates, when the embedded system is turned on. The functions configured within the first boot loader correspond to functions, such as the performing of the POST or the setting of the communication interface, which do not need to be upgraded while the boot loader is being loaded, and may be configured with functions which a general user cannot arbitrarily change.

In operation 730, a flash memory identifier decoding module may be loaded. The flash memory identifier decoding module may include an EMID decoder. The EMID decoder may request an identifier of a flash memory from the flash memory, and may decode information received from the flash memory to restore it as the identifier of the flash memory. Furthermore, the flash memory identifier decoding module may decode an encrypted administrative privilege granting code which will be described below, using the acquired identifier of the flash memory.

When the loading of the flash memory identifier decoding module fails in operation 730, the controller may generate a system error message, and may terminate the system booting process in operation 790. When the loading of the flash memory identifier decoding module fails, this may imply that the decoding module has been arbitrarily changed by an unauthenticated user. When the flash memory identifier decoding module has been changed, the authenticated user is likely to access the administrative privilege. Due to this, when the loading of the flash memory identifier decoding module fails in operation 730, a system error may occur.

After the flash memory identifier decoding module has been loaded in operation 730, the controller may load a second boot loader in operation 740. The second boot loader may be configured with functions predicted to be upgraded, such as a function for loading the kernel. The second boot loader performs a preparation process required for execution of the kernel, loads the kernel in the internal memory of the embedded system, and forwards control to the kernel. The loading of the first boot loader and the loading of the second boot loader may also be performed by one procedure.

In operation 750, kernel loading is initiated. When the kernel loading is initiated, a data structure used by a process, a memory, and a kernel is initialized.

The loading of the flash memory identifier decoding module in operation 730 may also be performed after the kernel loading is initiated in operation 750.

In the kernel loading process, the controller may selectively authenticate the identifier of the flash memory in operation 760. For example, the controller may determine whether the identifier of the flash memory obtained by making a request to the flash memory by the flash memory identifier decoding module is the same as the identifier stored in advance in the memory. At this time, the identifier stored in advance in the memory may be the identifier used and stored when the administrative privilege granting code has been encrypted as described above with reference to FIGS. 2 to 5.

When the identifier of the flash memory acquired from the flash memory is different from the pre-stored identifier, a user is likely to attempt to change hardware. When the hardware has been changed, the unauthenticated user is more likely to access the administrative privilege, or may attempt to decode the encrypted administrative privilege granting code using the changed hardware. Accordingly, when the authentication for the identifier of the flash memory fails, a system error may occur in operation 790.

In operation 770, the controller decodes the encrypted administrative privilege granting code using the identifier of the flash memory acquired through the flash memory identifier decoding module loaded in operation 730.

When the decoding of the administrative privilege granting code succeeds in operation 770, the controller completely boot up the device through a normal booting process in operation 780. When the decoding of the administrative privilege granting code fails in operation 770, a system error may occur in operation 790.

Since the device according to an embodiment of the present disclosure may encrypt the administrative privilege granting code using the unique identifier of the flash memory as described above, the encryption may be differently performed for each device. At this time, in the case where the device having the encrypted administrative privilege granting code is booted up, the encrypted administrative privilege granting code needs to be decoded. In this case, the encrypted administrative privilege granting code is decoded using the identifier of the flash memory used for the encryption. That is, the administrative privilege granting code has been encrypted with the identifier of the flash memory which is unique to the device, and the encrypted administrative privilege granting code may be decoded with the identifier of the flash memory which has been used for the encryption. Accordingly, in one system, the encrypted administrative privilege granting code may be decoded only through the one specific identifier of the flash memory.

Due to this, an arbitrary code change by an unauthenticated user may be fundamentally prevented. That is, in the case where the encrypted administrative privilege granting code is changed to the unencrypted administrative privilege granting code, when decoding is attempted with the identifier of the flash memory used for the encryption, the decoding may not be normally performed, and an error message may be generated.

Furthermore, since the unique identifier of the flash memory is used in the decoding process, when the unauthenticated user attempts to access the administrative privilege such as to change the encrypted administrative privilege granting code, the decoding process may not be performed, thereby blocking the attempt to access the administrative privilege. That is, in the case where the administrative privilege granting code of the present device is changed to the administrative privilege granting code encrypted with the identifier of another flash memory, the present device performs the decoding process with the identifier of the flash memory according to the present device. At this time, since the identifier used for the encryption and the identifier used for the decoding are different from each other, namely, the decoding is not performed according to the normal decoding code, the decoding may not be performed, and an error message may be generated.

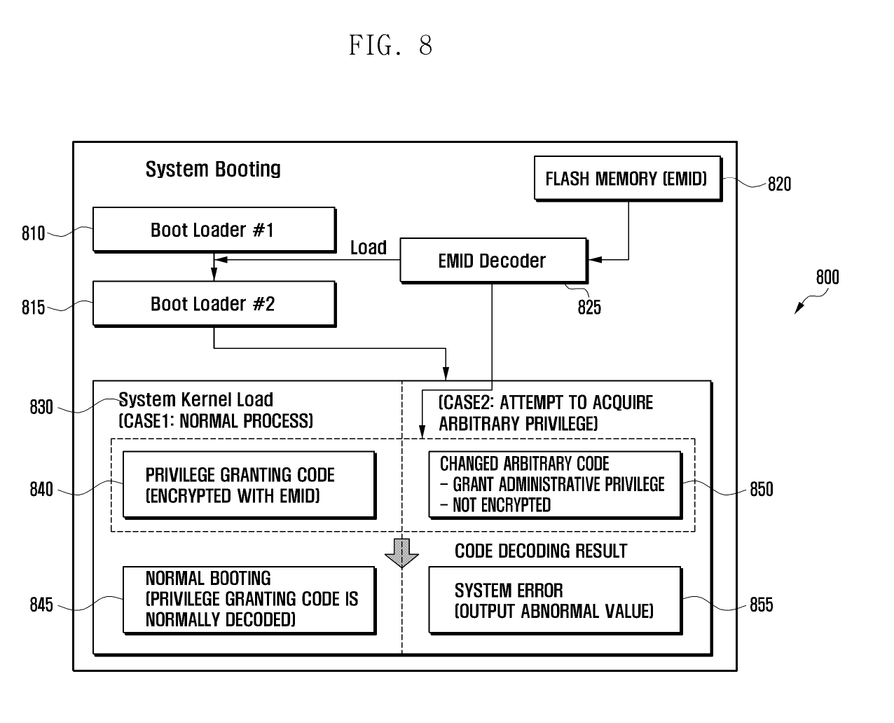

FIG. 8 is a view schematically illustrating a booting process of a device according to an embodiment of the present disclosure.

Referring to FIG. 8, system booting of a device 800 according to the present disclosure is performed. At this time, a first boot loader may be loaded, and a flash memory identifier decoding module, for example, an EMID decoder 825 may be loaded to acquire EMID from a flash memory 820 including the EMID. After the EMID decoder 825 is loaded, a second boot loader may be loaded in operation 815.

Since the first boot loader 810, the second boot loader 815, and the flash memory identifier decoding module 825 have been described with reference to FIG. 7, specific descriptions thereof will be omitted.

When a system kernel 830 is loaded, an administrative privilege granting code is decoded using the identifier of the flash memory, for example, the EMID acquired by the EMID decoder 825.

When the administrative privilege granting code is a normally encrypted administrative privilege granting code 840, the decoding may be normally performed using the EMID acquired by the EMID decoder 825 (845). That is, when the administrative privilege granting code of the device 800 illustrated in FIG. 8 is the administrative privilege granting code 840 normally encrypted by the method exemplified in the descriptions associated with FIGS. 2 to 5, normal booting may be performed (845).

On the contrary, when the administrative privilege granting code is changed to an arbitrary code 850, the normal booting may not be performed (855). That is, the normally encrypted administrative privilege granting code 840 may be changed to the arbitrary code 850 by an unauthenticated user. At this time, since the arbitrary code 850 is not the code encrypted by the normal method, when decoding is performed using the EMID acquired when the kernel is loaded, a system error may occur (855).

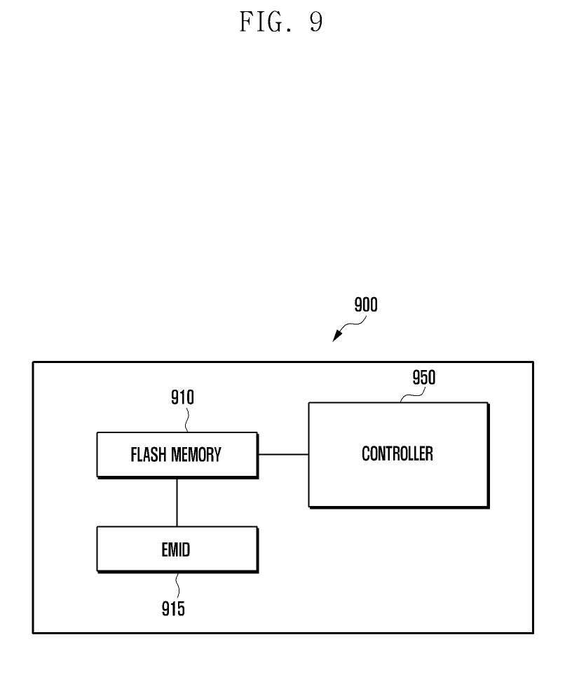

FIG. 9 is a block diagram schematically illustrating a device according to an embodiment of the present disclosure.

Referring to FIG. 9, a device 900 may include a flash memory 910 and a controller 950. The flash memory 915 may include an identifier 915 of the flash memory. The identifier 915 of the flash memory may be EMID. The flash memory 910 may store a boot loader, an administrative privilege granting code, and the like.

The controller 950 may perform the operations of the device as described above with reference to FIGS. 2 to 8. For example, the controller 950 may acquire the identifier 915 of the flash memory from the flash memory 910 when the device is first executed, and may encrypt an administrative privilege granting code using the identifier 915 of the flash memory. Furthermore, the controller 950 may encrypt the administrative privilege granting code according to an encryption executing code using the identifier 915 of the flash memory, and may delete the encryption executing code.

Moreover, when the device is loaded, the controller 950 may start kernel loading, acquire the flash memory identifier 915 from the flash memory 910, decode the encrypted administrative privilege granting code using the flash memory identifier 915, and complete booting when the decoding succeeds.

Although the administrative privilege granting code is exemplified as the encryption target code in the present specification, the encryption target code is not limited thereto. An arbitrary code for restricting access by an unauthenticated user in addition to the administrative privilege granting code may be encrypted and decoded according to the encryption method of the present disclosure.

Various embodiments of the present disclosure disclosed in the specification and the drawings are only particular examples to easily describe the technical matters of the present disclosure and assist in understanding of the present disclosure, but do not limit the scope of the present disclosure. It is apparent to those skilled in the art that other modified examples based on the technical idea of the present disclosure can be implemented as well as the various embodiments disclosed herein.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of preventing access to an administrative privilege of a device, the method comprising:
acquiring a flash memory identifier from a flash memory;
starting kernel loading;
decoding an encrypted administrative privilege granting code using the flash memory identifier; and
completing booting when the decoding succeeds.

2. The method of claim 1, further comprising:
generating a system error when the decoding fails.

3. The method of claim 1, wherein the starting of the kernel loading comprises:
loading a boot loader;
loading a flash memory decoding module; and
starting the kernel loading when the flash memory decoding module is loaded.

4. The method of claim 3, further comprising:
generating a system error when the loading of the flash memory decoding module fails.

5. The method of claim 1, wherein the decoding of the administrative privilege granting code comprises:
determining whether the flash memory identifier is the same as a pre-stored identifier; and
decoding the encrypted administrative privilege granting code using the flash memory identifier when the flash memory identifier is the same as the pre-stored identifier.

6. The method of claim 5, further comprising:
generating a system error when the flash memory identifier is not the same as the pre-stored identifier.

7. The method of claim 1, further comprising:
acquiring an identifier of the flash memory from the flash memory; and
encrypting an administrative privilege granting code using the identifier of the flash memory.

8. The method of claim 7, wherein the encrypting of the administrative privilege granting code comprises:
encrypting the administrative privilege granting code with an encryption executing code by using the identifier of the flash memory; and
deleting the encryption executing code.

9. A device for preventing access to an administrative privilege, the device comprising:
a flash memory comprising a flash memory identifier; and
a controller configured to acquire a flash memory identifier from a flash memory, start kernel loading, decode an encrypted administrative privilege granting code using the flash memory identifier, and complete booting when the decoding succeeds.

10. The device of claim 9, wherein the controller generates a system error when the decoding of the encrypted administrative privilege granting code fails.

11. The device of claim 9, wherein the controller loads a boot loader, loads a flash memory decoding module, and starts the kernel loading when the flash memory decoding module is loaded.

12. The device of claim 11, wherein the controller generates a system error when the loading of the flash memory decoding module fails.

13. The device of claim 9, wherein the controller determines whether the flash memory identifier is the same as a pre-stored identifier, and decodes the encrypted administrative privilege granting code using the flash memory identifier when the flash memory identifier is the same as the pre-stored identifier.

14. The device of claim 13, wherein the controller generates a system error when the flash memory identifier is not the same as the pre-stored identifier.

15. The device of claim 9, wherein the controller acquires an identifier of the flash memory from the flash memory, and encrypts an administrative privilege granting code using the identifier of the flash memory.

16. The device of claim 15, wherein the controller encrypts the administrative privilege granting code with an encryption executing code by using the identifier of the flash memory, and deletes the encryption executing code.
